(19) United States
(12) Patent Application Publication
(10) Pub. No.: US 2020/0250913 A1
(43) Pub. Date: Aug. 6, 2020

(54) VOTING FACILITY FOR SMALL COMMUNITIES

(71) Applicant: Narendra Reddy Thappeta, Bangalore (IN)

(72) Inventor: Narendra Reddy Thappeta, Bangalore (IN)

(21) Appl. No.: 16/740,512

(22) Filed: Jan. 13, 2020

(30) Foreign Application Priority Data
Feb. 5, 2019 (IN) 201941004595

(51) Int. Cl. G07C 13/00

(52) U.S. Cl. CPC G07C 13/00

(57) ABSTRACT

Aspects of the present disclosure are directed to facilitate voting in small communities. In an embodiment, a unique private identifier is generated for each voter in the community. During the voting process, a set of choices is received from each voter. The set of choices thus received are then stored along with the corresponding unique private identifier for that voter. Finally, the results of the voting are determined based on the sets of choices of all the voters in the community. According to an aspect, the results of the voting are provided as a table containing the unique private identifiers and the corresponding set of choices for each of the voters. In an embodiment, the unique private identifier is generated by hashing a corresponding unit number (of the residence) of the voter which uniquely identifies each voter.

### PRIORITY CLAIM

The instant patent application is related to and claims priority from the co-pending India provisional patent application entitled, “VOTING FACILITY IN A COMMUNITY ELECTRONIC PORTAL”, Serial No.: 201941004595, Filed: 5 Feb. 2019, naming as inventor Narendra Reddy Thappeta, attorney docket number: NT-6003-INPR, which is incorporated in its entirety herewith.

### BACKGROUND OF THE DISCLOSURE

### Technical Field

The present disclosure relates to electronic voting systems and more specifically to voting facility in small communities.

### Related Art

Small communities (groups of associated people such as residential communities) often use electronic portals for administration and various organizational purposes. Administrative activities include, for example, collection of any due amounts, monitoring any service requests, etc. Organizational purposes include providing medium for communications.

There is often a need to provide voting facility in such electronic community portals. Voting can be for purposes such as electing representatives/members of management committee or aiding decision making in other aspects in the community.

The voting facility needs to meet the requirements and expectations of the community as suited in their corresponding purpose. There are at least three potential requirements that a voting facility needs to meet:

(A) Integrity—Each voter should be able to confirm that his/her choices have been recorded as intended.

(B) Secrecy—The choices of a voter should be confidential.

(C) Access—Voters should have a number of ways to vote.

Aspects of the present disclosure provide for voting facility in an electronic portal in small communities meeting all the above requirements.

### BRIEF DESCRIPTION OF THE DRAWINGS

Example embodiments of the present disclosure will be described with reference to the accompanying drawings briefly described below.

FIG. 1 is a block diagram illustrating an example environment (computing system) in which several aspects of the present disclosure can be implemented.

FIG. 2 is a flow chart illustrating the manner in which voting is facilitated according to an aspect of the present disclosure.

FIG. 3A depicts sample voter information available in a community portal.

FIG. 3B depicts sample voter choices in a community portal.

FIG. 3C depicts sample spreadsheet published on a community portal.

FIG. 4 is a block diagram illustrating the details of a digital processing system in which several aspects of the present disclosure are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

Aspects of the present disclosure are directed to facilitate voting in small communities. In an embodiment, a unique private identifier is generated for each voter in the community. During the voting process, a set of choices is received from each voter. The set of choices thus received are then stored along with the corresponding unique private identifier for that voter. Finally, the results of the voting are determined based on the sets of choices of all the voters in the community.

According to an aspect, the results of the voting are provided as a table containing the unique private identifiers and the corresponding set of choices for each of the voters.

In an embodiment, the unique private identifier is generated by hashing a corresponding unit number (of the residence) of the voter which uniquely identifies each voter.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

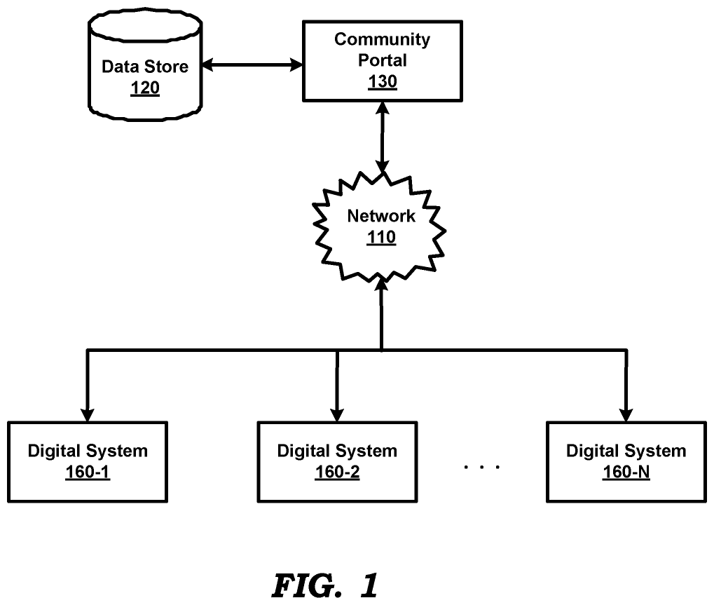

FIG. 1 is a block diagram illustrating an example environment (computing system) in which several aspects of the present disclosure can be implemented. The block diagram is shown containing network 110, data store 120, community portal 130 and digital systems 160-1 to 160-N (N representing any arbitrary positive number). Digital systems 160-1 to 160-N are collectively or individually referred by referral numeral 160, as will be clear from the context.

Merely for illustration, only representative number/type of systems are shown in FIG. 1. Many environments often contain many more systems, both in number and type, depending on the purpose for which the environment is designed. Each block of FIG. 1 is described below in further detail.

Network 110 provides connectivity between digital systems 160-1 to 160-N and community portal 130, and may be implemented using protocols such as Transmission Control Protocol (TCP) and/or Internet Protocol (IP), well-known in the relevant arts. In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered.

An IP packet is said to be directed to a target system when the destination IP address of the packet is set to the IP address of the target system, such that the packet is eventually delivered to the target system by network 110. When the packet contains content such as port numbers, which specifies the destination application, the packet may be said to be directed to such application as well. The destination system may be required to keep the corresponding port numbers available/open, and process the packets with the corresponding destination ports. Network 110 may be implemented using any combination of wire-based or wireless mediums.

Data store 120 represents a non-volatile (persistent) storage facilitating storage and retrieval of a collection of data by community portal 130. Data store 120 may be implemented as a database server using relational database technologies and accordingly provide storage and retrieval of data using structured queries such as SQL (Structured Query Language). Alternatively or in addition, data store 120 may be implemented as a file server providing storage and retrieval of data in the form of files organized as one or more directories, as is well-known in the relevant arts.

Each of digital systems 160-1 to 160-N represents a corresponding end user system such as a personal computer, mobile phones, computing tablets, etc used by the voter. The voter may download the community portal app on his/her mobile and vote. Alternatively, the voter may access a web-based application on community portal 130 and vote.

Community portal 130 represents a server, such as a web/application server, which may host the community portal. Voters may access community portal 130 for exercising their voting rights. Community portal 130 may contain internal components (not shown) to generate hash, store the voter choices and to calculate results of the voting. According to an aspect of the present disclosure, community portal 130 operates to facilitate voting in the community as described below.

### 3. Flowchart

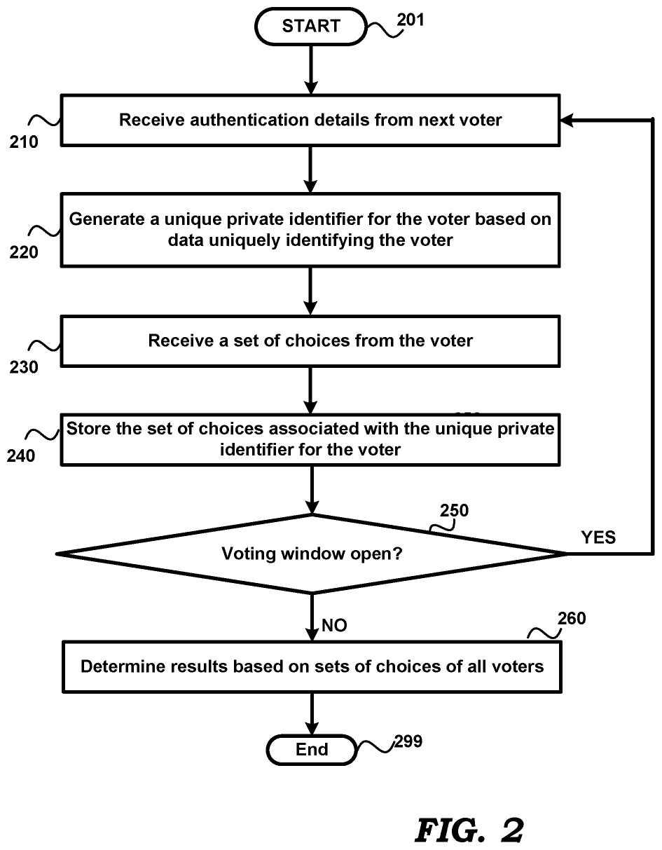

FIG. 2 is a flowchart illustrating the manner in which voting is facilitated in an electronic portal of small communities. The flowchart is described with respect to the systems of FIG. 1 merely for illustration. However, many of the features can be implemented in other systems and/or other environments also without departing from the scope and spirit of several aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure. The flow chart begins in step 201, in which control immediately passes to step 210.

In step 210, community portal 130 receives authentication details from the voter when the voter tries to access the portal using, e.g. a login id and password. Community portal 130 verifies the credentials of the voter using the data stored in data store 120 to allow access to the portal for the voter. In addition to verifying the login credentials, community portal 130 may optionally employ biometric verification (e.g. Aadhaar-based biometric) for making the process more secure. Once the credentials are verified, control passes to step 220.

In step 220, community portal 130 generates a unique private identifier for the voter based on the information retrieved from the data store. Each voter may already have a unique public identifier (for example a unit number, assuming each residential unit has one vote) in the community portal. However, it is undesirable to store the voter choices with the publicly available unique identifier of the voter as the identity of the voter may be easily known from such identifier. This in turn violates the secrecy requirement of the voter. A unique private identifier is designed such that the identity of the voter is concealed (not discernible by the public), but the voter has clear knowledge that the private identifier is uniquely hers/his. Thus, the unique private identifier may guarantee that identity of the voter may not be deciphered publicly even though the generated unique private identifier is made public.

In an embodiment, the unit number of the residence of the voter may be used to generate the unique private identifier for the voter. The identifier may be generated as a hash value of the unit number of the voter. Control passes to step 230.

In step 230, community portal 130 receives a set of choices from the voter for the ongoing voting process. Depending on the end goal of the voting (e.g. decision-making poll or election of committee members), the choices may be a simple Yes/No or a set of choices from a pre-defined list of choices. Once the voter confirms his/her choices, the voter may optionally request for a receipt of the vote. Community portal 130 may generate a receipt (for private/personal purpose) containing the unique private identifier of the voter and the set of choices and send an email with the details. Control passes to step 240.

In step 240, community portal 130 stores the set of choices of the voter along with the corresponding unique private identifier associated with the voter (generated in step 220). Control passes to step 250.

In step 250, community portal 130 determines if the voting window is open. The voting window is a pre-defined period of time during which voters can register their choices on the community portal. If the voting window is open and there is another voter, control passes to step 210 and to step 260 otherwise.

In step 260, community portal 130 determines the result of the voting by counting the sets of choices of all the voters. Community portal 130 may also conveniently publish the individual choices of voters. Such a list of choices would only contain the unique private identifiers of the voters and the corresponding set of choices. As the unique private identifiers are not decipherable, the secrecy of the choices of the voter is ensured. Also, each voter may verify that his/her set of choices have been registered as intended by checking against the unique private identifier. The flowchart ends in step 299.

The description is continued with respect to illustrating some of the above noted features with respect to sample data.

### 4. Example Implementation

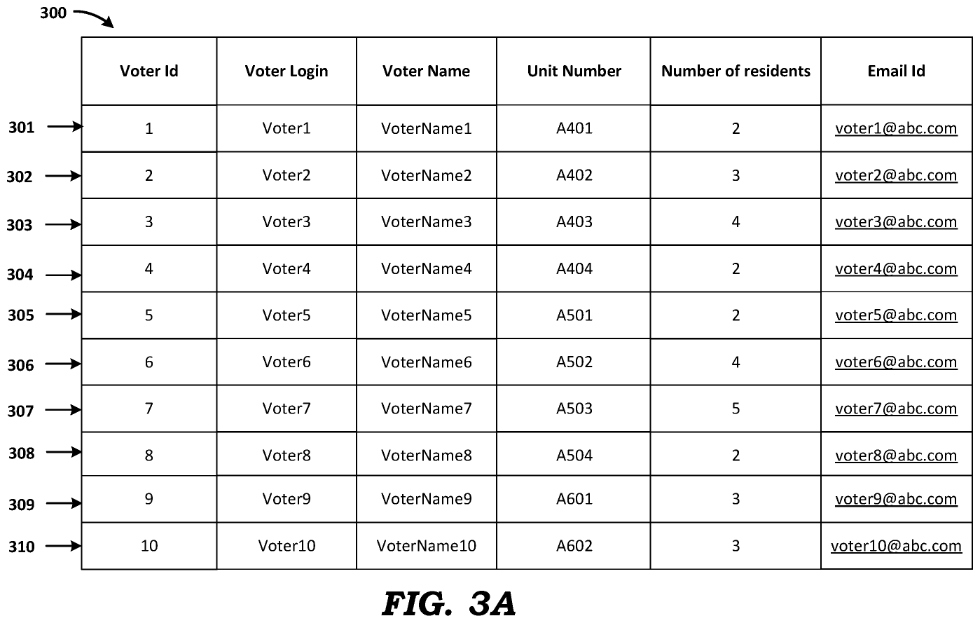

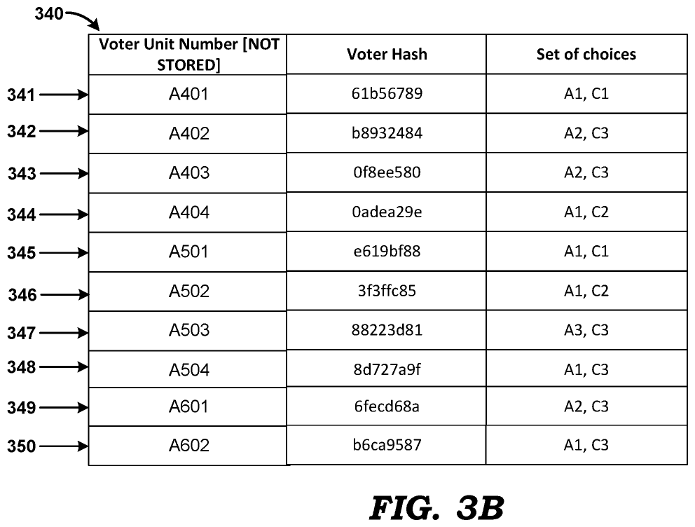

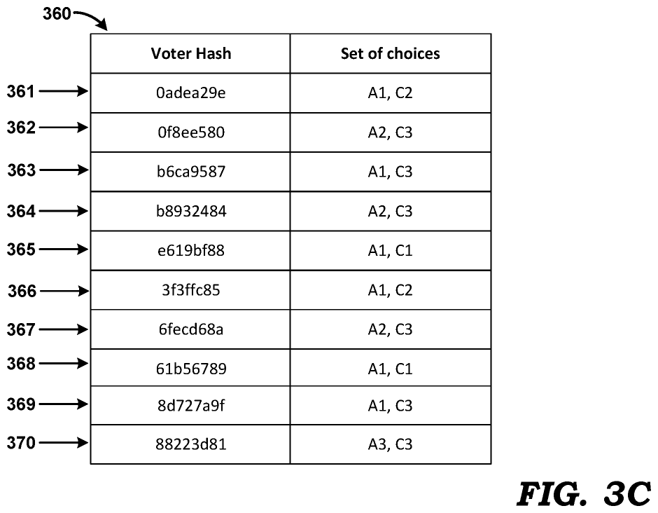

FIG. 3A depicts sample voter information available publicly in a community portal. Specifically, table 300 is shown containing 10 rows [rows 301-310]. Only some of the fields of the voter table, as relevant to an understanding of the disclosure, are depicted in the Figure for conciseness. Also, the community portal data store would contain many more tables and many more rows as will also be apparent to persons skilled in the art.

Column “Voter Id” specifies a running sequence id for a voter. This column uniquely identifies the voter in data store 120. Column “Voter Login” specifies a login used by the voter to access the community portal. Column “Voter Name” specifies the name of the voter. Column “Unit Number” specifies the unit number of the residence of the voter. Column “Number of residents” specifies the number of people residing in the unit. Column “Email Id” specifies the email id of the voter.

In this illustrative embodiment, it is assumed that only one vote may be allowed per unit in the community. Thus, the unit number serves as a unique private identifier for each voter. It may be appreciated that the “Voter Id” may not be used to generate the unique private identifier as there may be two voters from the same unit number using community portal 130. However, only one resident may exercise his/her voting right from that unit number.

FIG. 3B depicts the manner in which voter choices are stored by community portal 130. Specifically, table 340 is shown containing 3 columns and 10 rows [rows 341-350]. It may be noted that column ‘Voter Unit Number” is shown in FIG. 3B only for convenience of understanding the implementation and is not actually stored in table 340. Column “Voter Hash” depicts the hash generated from the voter unit number using any well-known hashing function. Column “Set of Choices” depicts a list of comma-separated choices selected by the voter during voting. In this illustrative embodiment, it is assumed that the voting choices available to the voter are from a list of [A1-A3] for the first choice and [C1-C3] for the second choice.

FIG. 3C depicts a sample spreadsheet of voter choices with the unique private identifier column sorted in ascending order.

The description is continued below with respect to illustrating the manner in which community portal 130 facilitates voting in small communities.

### 5. Voting Facility

A voter in a community may exercise his/her vote in any one of the following ways:

1. Mobile voting—A voter may download an app of the community portal on his/her mobile phone and use the same to vote.

2. Web voting—A voter may access the community portal website hosted by community portal 130 to exercise his/her vote.

3. Email voting—A voter may vote by clicking a link sent to his/her email address. Community portal 130 may send the email to voters indicating the voting choices and the duration of the voting window. The voter may be able to exercise his/her vote only during the voting window. Alternatively, a voter may fill a file (e.g. a PDF file) indicating his/her set of choices and send the same by email to a designated email address.

4. Kiosk voting—A voter may vote by visiting a computer kiosk provided at the community office. Such a computer kiosk (not shown) may communicate the voter choices to community portal 130 via Network 110.

Such a large number of ways to vote ensures the access requirement of the voting facility. It may be appreciated that the means of voting is not restricted to the above mentioned list.

In the illustrative embodiment, it is assumed there is an ongoing voting process and the voter has the following available options for two choices:

Choice 1—A1, A2, A3

Choice 2—C1, C2, C3

Community portal 130 may enable access to the voting process to the voters only during the voting window. Voters may access the portal during the voting window by providing authentication details (e.g. login id and password).

It is assumed that Voter2 [row 302 in table 300] provides the authentication details to community portal 130.

As depicted in the flowchart of FIG. 2, community portal 130 may first verify the credentials of a voter using the authentication details. Community portal 130 may use the information in table 300 to perform the verification. Community portal 130 may also ensure uniqueness of the vote by ensuring that a voter exercises his/her voting rights only once.

Once community portal 130 verifies the authenticity of the voter, community portal 130 retrieves the unit number, A402, of the residence of the voter. Community portal 130 then generates a hash, e.g., b8932484, of the unit number. The hash may be generated using any well known hash function. In an embodiment, community portal 130 may randomly choose one hash function from a list of pre-defined hash functions for each election/poll and apply the same hash function for all voters for that election/poll. This ensures that a new hash value is generated for each voter in each election/poll, thus providing for greater security.

Community portal 130 then lists the choices available to the voter as part of the voting. It is assumed that Voter2 selects A2 as the first choice and C3 as the second choice. Community portal 130 stores the set of choices and the generated hash of the voter (as depicted in row 342 of table 340 in FIG. 3B).

After casting his/her vote, a voter may choose to get a receipt for the voting choices. When the voter indicates thus, community portal 130 may send an email to the voter with the corresponding hash and the set of choices of the voter. The voter may keep the email privately for reference.

Community portal 130 continues in the above manner for all voters as long as the voting window is open and there are more voters. When the voting window is closed, community portal 130 restricts further access to voters. Community portal 130 then aggregates the sets of choices of all voters to generate the results.

As can be seen from table 340, the aggregated data (selections) for the choices is:

Choice 1

A1—6 [rows 341, 344-346, 348, 350]

A2—3 [rows 342, 343, 349]

A3—1 [row 347]

Choice 2

C1—2 [rows 341, 345]

C2—2 [rows 344, 346]

C3—6 [rows 342, 343, 347-350]

Thus, community portal 130 determines the results of the voting as “A1” for choice 1 and “C3” for choice 2.

Community portal 130 may publish the results in an aggregated form or as individual rows in a spreadsheet. It may be appreciated that when individual rows are published, only the hash of each voter is displayed with the associated set of choices. Thus, secrecy of the voter may be ensured since the unique identifier is a hash value and may not be deciphered.

In case a certain voter wishes to verify that his/her vote has been counted as intended, he/she may request for a receipt soon after voting as described above. The voter may then cross verify his/her choices in the spreadsheet by comparing the corresponding hash. Thus, integrity of voting is ensured. Since a voter will know only his/her own unique identifier and not that of other voters, both secrecy and integrity of voting are taken care of.

It may be appreciated that it can be challenging for each voter to individually verify his/her own from the spreadsheet noted above. According to an aspect, the voting choices are sorted according to voter hash and published as a spreadsheet table as depicted in table 360 [rows 361-370] of FIG. 3C. It may be further appreciated that the hash numbers are not user-friendly for someone to verify his/her personal vote.

According to another aspect, the unique private identifier is further augmented by a random numerical value, which is appended to the front (prefixed) of the voter hash to form the unique private identifier. For example, if a random number of 2486 is generated for the voter of row 341, the unique private identifier for that voter will be 248661b56789. Thus, when sorted by the unique private identifiers, the voters can easily identify their own voting choices but not those of other voters. It may be appreciated that the use of random numbers alone may not serve the purpose given the possibility (however remote) of two random numbers being identical.

In this manner, community portal 130 provides voting facility in small communities. However, the features of the present disclosure can be implemented external to the community portals (e.g., as a part of SurveyMonkey type software services) without departing from the scope and spirit of several aspects of the present disclosure. An administrator may first sign up for conducting voting and a unique identifier for that voting event may be generated by the external system and communicated to the administrator. The administrator may specify various questions/choices. Each voter may participate in the voting event based on the unique identifier.

It should be appreciated that the features described above can be implemented in various embodiments as a desired combination of one or more of hardware, software, and firmware. The description is continued with respect to an embodiment in which various features are operative when the software instructions described above are executed.

### 6. Digital Processing System

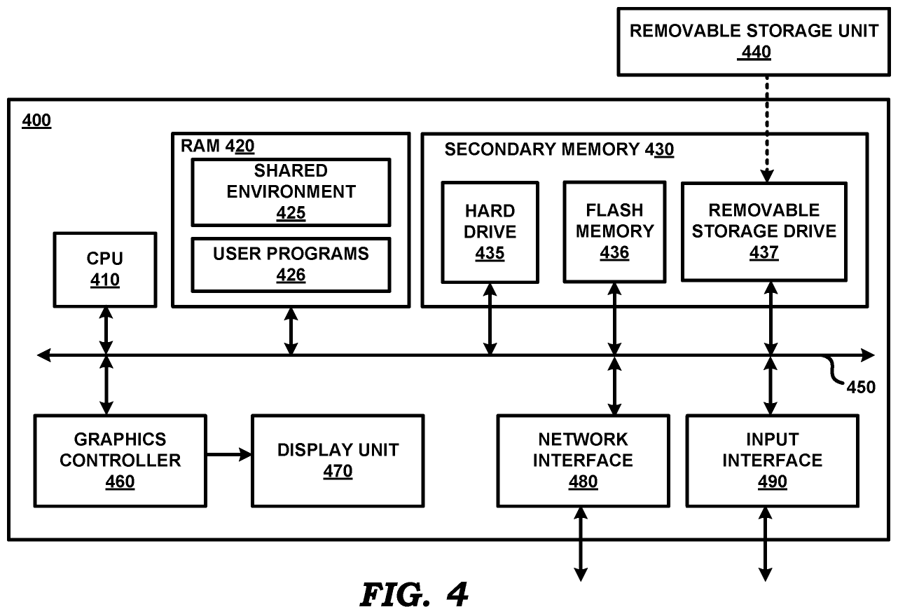

FIG. 4 is a block diagram illustrating the details of digital processing system 400 in which various aspects of the present disclosure are operative by execution of appropriate executable modules. Digital processing system 400 may correspond to one of digital system 160 and community portal 130 (or external system noted above).

Digital processing system 400 may contain one or more processors such as a central processing unit (CPU) 410, random access memory (RAM) 420, secondary memory 430, graphics controller 460, display unit 470, network interface 480, and input interface 490. All the components except display unit 470 may communicate with each other over communication path 450, which may contain several buses as is well-known in the relevant arts. The components of FIG. 4 are described below in further detail.

CPU 410 may execute instructions stored in RAM 420 to provide several features of the present disclosure. CPU 410 may contain multiple processing units, with each processing unit potentially being designed for a specific task. Alternatively, CPU 410 may contain only a single general-purpose processing unit. In addition, CPU 410 may be supported by CAM (content addressable memory) structures for examination of complex patterns.

RAM 420 may receive instructions from secondary memory 430 using communication path 450. RAM 420 is shown currently containing software instructions constituting shared environment 425 and/or other user programs 426 (such as the blocks of community portal 130 or digital system 160 shown in FIG. 3). In addition to shared environment 425, RAM 420 may contain other software programs such as device drivers, virtual machines, etc., which provide a (common) run time environment for execution of other/user programs.

Graphics controller 460 generates display signals (e.g., in RGB format) to display unit 470 based on data/instructions received from CPU 410. Display unit 470 contains a display screen to display the images defined by the display signals. Input interface 490 may correspond to a keyboard and a pointing device (e.g., touch-pad, mouse) and may be used to provide inputs. Network interface 480 provides connectivity to a network (e.g., using Internet Protocol), and may be used to communicate with other systems (of FIG. 1) connected to the networks (110).

Secondary memory 430 may contain hard drive 435, flash memory 436, and removable storage drive 437. Secondary memory 430 may store the data and software instructions (for example, for implementing the various features of the present disclosure as shown in FIG. 2, etc.), which enable digital processing system 400 to provide several features in accordance with the present disclosure. The code/instructions stored in secondary memory 430 may either be copied to RAM 420 prior to execution by CPU 410 for higher execution speeds, or may be directly executed by CPU 410.

Some or all of the data and instructions may be provided on removable storage unit 440, and the data and instructions may be read and provided by removable storage drive 437 to CPU 410. Removable storage unit 440 may be implemented using medium and storage format compatible with removable storage drive 437 such that removable storage drive 437 can read the data and instructions. Thus, removable storage unit 440 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 440 or hard disk installed in hard drive 435. These computer program products are means for providing software to digital processing system 400. CPU 410 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 430. Volatile media includes dynamic memory, such as RAM 420. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 450. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 7. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method of facilitating voting, the method comprising:
generating a corresponding unique private identifier for each voter of a plurality of voters;
receiving a corresponding set of choices from each voter;
storing the corresponding set of choices associated with the corresponding unique private identifier for each voter,
wherein results of the voting are determined based on the sets of choices of the plurality of voters.

2. The method of claim 1, further comprising providing a table containing the corresponding unique private identifiers and the corresponding set of choices for each of the plurality of voters,
wherein the table is examined for determining the results.

3. The method of claim 1, wherein the unique private identifier is generated by hashing a corresponding input uniquely identifying each voter.

4. The method of claim 3, wherein the voting is for a residential community and the corresponding input comprises a unit number of a residence of the voter in the residential community.

5. The method of claim 2, wherein the unique private identifiers in the table may be prefixed with a random integer and then sorted for publishing the results in a spreadsheet.

6. A non-transitory machine readable medium storing one or more sequences of instructions to facilitate voting, wherein execution of the one or more instructions by one or more processors contained in a digital system enables the digital system to perform the actions of:
generating a corresponding unique private identifier for each voter of a plurality of voters;
receiving a corresponding set of choices from each voter;
storing the corresponding set of choices associated with the corresponding unique private identifier for each voter,
wherein results of the voting are determined based on the sets of choices of the plurality of voters.

7. The non-transitory machine readable medium of claim 6, further comprising:
providing a table containing the corresponding unique private identifiers and the corresponding set of choices for each of the plurality of voters,
wherein the table is examined for determining the results.

8. The non-transitory machine readable medium of claim 6, wherein the unique private identifier is generated by hashing a corresponding input uniquely identifying each voter.

9. The non-transitory machine readable medium of claim 8, wherein the voting is for a residential community and the corresponding input comprises a unit number of a residence of the voter in the residential community.

10. A server system comprising:
at least one memory unit to store instructions; and
at least one processor to retrieve and execute the instructions wherein execution of the instructions causes the server system to perform the actions of:
generating a corresponding unique private identifier for each voter of a plurality of voters;
receiving a corresponding set of choices from each voter;
storing the corresponding set of choices associated with the corresponding unique private identifier for each voter,
wherein results of voting are determined based on the sets of choices of the plurality of voters.
